(19) United States
(12) Patent Application Publication
(10) Pub. No.: US 2002/0059319 A1
(43) Pub. Date: May 16, 2002

(54) Interface apparatus, printer, information processing method, and printing method

(76) Inventor: Toshio Sakurai, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/973,058

(22) Filed: Oct. 10, 2001

(30) Foreign Application Priority Data
Oct. 13, 2000 (JP) 312958-2000

(51) Int. Cl. G06F 12/00

(52) U.S. Cl. 707/200

(57) ABSTRACT

An interface apparatus which inputs information from an external apparatus. When the inputted information is information which was changed within a predetermined time, the information is invalidated. When the inputted information is not matched with a protocol, such information is skipped. Thus, complicated noise components can be removed.

### BACKGROUND OF THE INVENTION

1. Field of the Invention

The invention relates to an interface apparatus for inputting information from an external apparatus, a printer, an information processing method, and a printing method.

2. Related Background Art

A noise filter comprising a resistor, a capacitor, a coil, and the like is used in an interface apparatus which is used in a conventional information processing apparatus or image processing apparatus. A digital filter obtained by replacing those analog devices with a digital circuit is also used. FIG. 7 shows an example of a conventional circuit.

FIG. 7 is a circuit diagram showing an example of such a kind of interface apparatus.

In FIG. 7, reference numeral 101 denotes an I/F connector. The I/F connector 101 is connected to one end of a serial resistor 102 and the other end (which is not connected to the I/F connector 101) of the serial resistor 102 is connected to one end of a parallel capacitor 103 and an input device 104.

The other end (which is not connected to the serial resistor 102) of the parallel capacitor 103 is connected to a ground GND. By such a connection, the serial resistor 102 and parallel capacitor 103 form a low pass filter (LPF). High frequency components in digital information inputted to the I/F connector 101 are removed by the LPF comprising the serial resistor 102 and parallel capacitor 103 and the resultant digital information is inputted to the input device 104. Now, assuming that a frequency band of the digital information which is inputted to the I/F connector 101 is set to a passing band of the LPF, a signal in a band that is equal to or higher than such a passing band can be cut by the LPF.

Since the signal having a band that is equal to or higher than the band of the digital information is noise components, such a circuit functions as a noise filter.

However, a noise removing circuit according to a filter circuit having a single cut-off frequency like a conventional example cannot set an optimum cut-off frequency if a transmitting speed of the digital information is not constant.

Since a protocol of the digital information is not discriminated, there is a problem such that in case of a signal of the cut-off frequency or lower, even if noises which do not exist in the protocol are inputted, they cannot be removed, or the like.

### SUMMARY OF THE INVENTION

The invention is made to solve the foregoing problems and it is an object of the invention to provide an interface apparatus, a printer, an information processing method, and a printing method, in which noise components which are more complicated than that of a noise filter using conventional passive elements can be removed.

To accomplish the above object, according to the invention, there is provided an interface apparatus for inputting information from an external apparatus of the invention, comprising: a first circuit for, when the inputted information is information which was changed within a predetermined time, invalidating such information; and a second circuit for, when the inputted information is not matched with a protocol, skipping such information.

According to the invention, there is also provided a printer comprising: a first circuit for, when inputted information is information which was changed within a predetermined time, invalidating such information; a second circuit for, when the inputted information is not matched with a protocol, skipping such information; and a printer engine for printing the information fetched by the first circuit, that is, the information which was determined by the second circuit that it is matched with the protocol.

### BRIEF DESCRIPTION OF THE DRAWINGS

FIG. 1 is a block diagram showing an example of an interface apparatus according to the first embodiment of the invention;

FIG. 2 is a block diagram for explaining a construction of a glitch noise filter shown in FIG. 1;

FIG. 3 is a flowchart showing an example of a data processing procedure of the interface apparatus according to the invention;

FIG. 4 is a block diagram for explaining a construction of an interface apparatus according to the second embodiment of the invention;

FIG. 5 is a block diagram for explaining a construction of a glitch noise filter shown in FIG. 4;

FIG. 6 is a diagram for explaining a memory map in a memory medium for storing various data processing programs which can be read out by the interface apparatus according to the invention; and

FIG. 7 is a circuit diagram showing an example of such a kind of interface apparatus.

### DETAILED DESCRIPTION OF THE PREFERRED EMBODIMENTS

(First Embodiment)

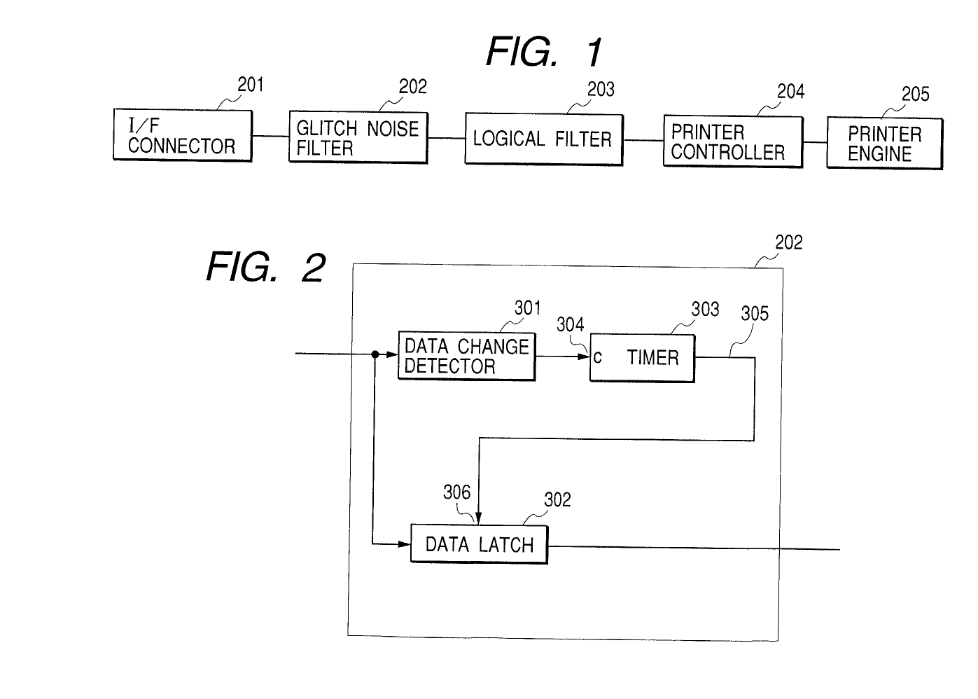

FIG. 1 is a block diagram showing an example of an interface apparatus according to the first embodiment of the invention.

In FIG. 1, reference numeral 201 denotes an I/F connector which is inputted from an outside. Digital information is inputted to the I/F connector 201 in a manner similar to the conventional one. The inputted digital information is inputted to a glitch noise filter 202. When the inputted information changes in a shorter time than a predetermined time, the glitch noise filter 202 invalidates the changed value. Reference numeral 203 denotes a logical filter having a function such that when information which is not matched with a protocol of the inputted digital information is inputted, such information is skipped according to the protocol. A printer controller 204 and a printer engine 205 are connected to the logical filter 203 and execute printing on the basis of the inputted information.

In case of the embodiment, it is assumed that digital data which is inputted from the outside has been formed lest it continuously has a same value. In this case, only when there is a difference in an output of the glitch noise filter 202, the logical filter 203 processes the input data as valid data.

FIG. 2 is a block diagram for explaining a construction of the glitch noise filter 202 shown in FIG. 1 and component elements similar to those shown in FIG. 1 are designated by the same reference numerals.

In FIG. 2, reference numeral 301 denotes a data change detector to which the digital information inputted to the glitch noise filter 202 is inputted and which detects the occurrence of a change in value of the inputted digital information. When there is a change, the data change detector 301 supplies it as a logic output to a reset input 304 of a timer 303. A predetermined time has been preset to the timer 303. The timer 303 generates a trigger (signal) 305 after the elapse of the predetermined time after a signal had been inputted to the reset input 304. The trigger 305 is inputted to a latch input 306 of a data latch 302.

The digital information inputted to the glitch noise filter 202 is inputted to the data latch 302.

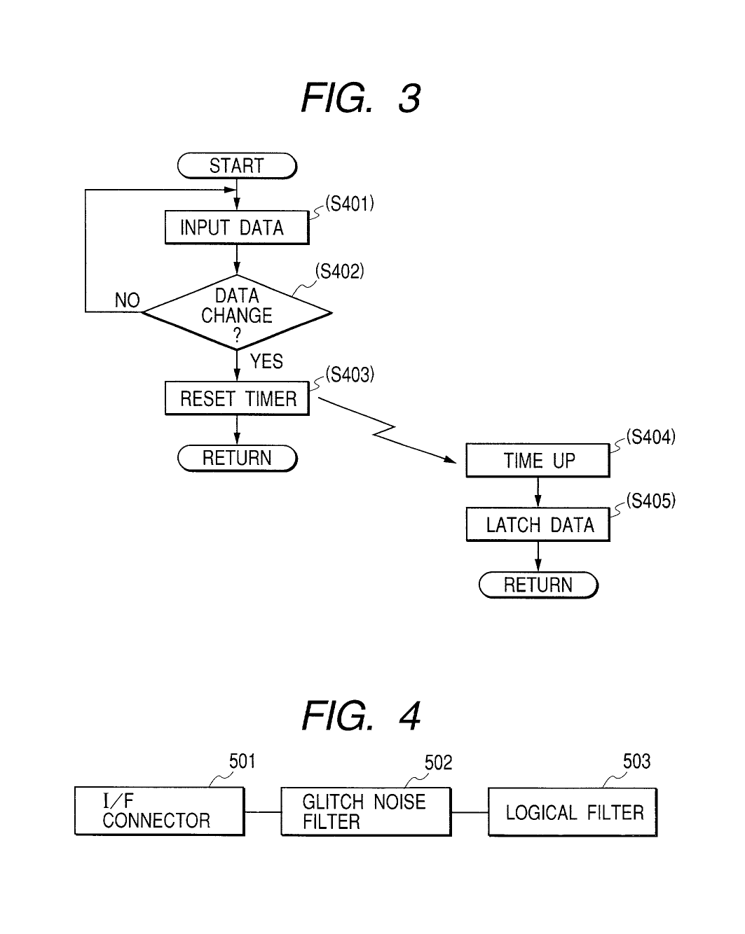

FIG. 3 is a flowchart showing an example of a data processing procedure of the interface apparatus according to the invention and corresponds to operation steps of the glitch noise filter 202 shown in FIG. 2. S401 to S405 denote processing steps, respectively.

First, in step S401, data is inputted through a predetermined communication medium. Whether there is a difference from previous data or not is discriminated in step S402. If it is decided that there is no difference, the processing routine is returned to step S401 and the data is inputted again.

If it is decided in step S402 that the difference of the data exists, the a timer (counter) is reset in step S403. The timer measures a predetermined time (counts clocks) in step S404. If the timer is reset in step S403 by new data during such a period of time, a count value of the timer is returned to an initial state and the counting operation of the predetermined time is executed again from such a time point. When the timer times up in step S404, the processing routine advances to step S405 and the data is fetched in response to the time-up of the timer.

The data (digital information) from which glitch noises have been removed by the glitch noise filter 202 as mentioned above is inputted to the logical filter 203. The logical filter 203 has a function such that when information which is not matched with the protocol of the inputted digital information is inputted, such information is skipped according to the protocol.

(Second Embodiment)

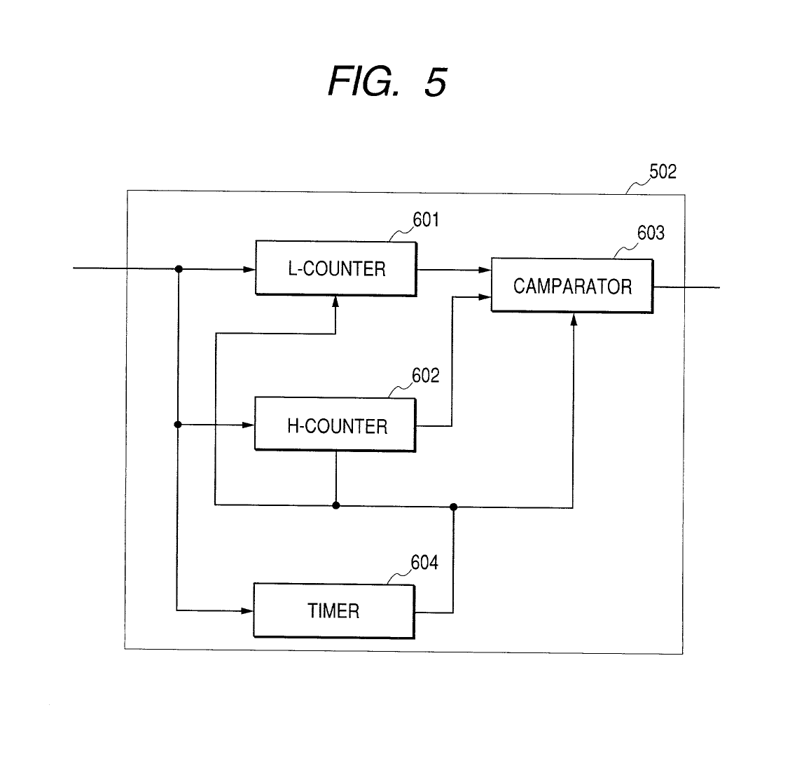

FIG. 4 is a block diagram for explaining a construction of an interface apparatus according to the second embodiment of the invention.

In FIG. 4, reference numeral 501 denotes an I/F connector which is inputted from the outside. Digital information is inputted to the I/F connector 501 in a manner similar to the conventional one. The inputted digital information is inputted to a glitch noise filter 502. When the inputted information changes in a shorter time than a predetermined time, the glitch noise filter 502 invalidates the changed value. Reference numeral 503 denotes a logical filter having a function such that when information which is not matched with a protocol of the inputted digital information is inputted, such information is skipped according to the protocol. For example, in the case where a protocol which does not continuously transmit same information is used, when the same information is continuously received, a process for skipping the information of the second time is executed. Information which does not exist in the protocol is held and when the information which does not exist in the protocol is inputted, such information is skipped.

In the interface apparatus constructed as mentioned above, glitch noises in the digital information inputted from the I/F connector 501 are removed. The digital information from which the glitch noises have been removed by the glitch noise filter 502 is inputted to the logical filter 503.

In the embodiment, the digital information is transmitted at specific time intervals and a strobe indicative of a delimiter of the data is included in the digital information itself.

FIG. 5 is a block diagram for explaining a construction of the glitch noise filter 502 shown in FIG. 4 and component elements similar to those shown in FIG. 4 are designated by the same reference numerals.

In FIG. 5, reference numeral 601 denotes an L-counter for recording a length of signal at the L level inputted to the logical filter 503 and 602 indicates an H-counter for recording a length of signal at the H level. Outputs of the L-counter 601 and H-counter 602 are inputted to a comparator 603. The comparator 603 generates an L-level signal when a count value of the L-counter 601 is larger than that of the H-counter 602. The comparator 603 generates an H-level signal when the count value of the H-counter 602 is larger than that of the L-counter 601.

Reset inputs of the L-counter 601 and H-counter 602 are connected to a count output of a timer 604. A reset input of the timer 604 is connected to the strobe indicative of the delimiter of the data.

In the glitch noise filter 502, the comparator 603 generates an L-level signal or an H-level signal according to the comparison between the count values of the L-counter and the H-counter as discussed above, within a predetermined time preset in the timer 604 from the resetting of the timer by the strobe.

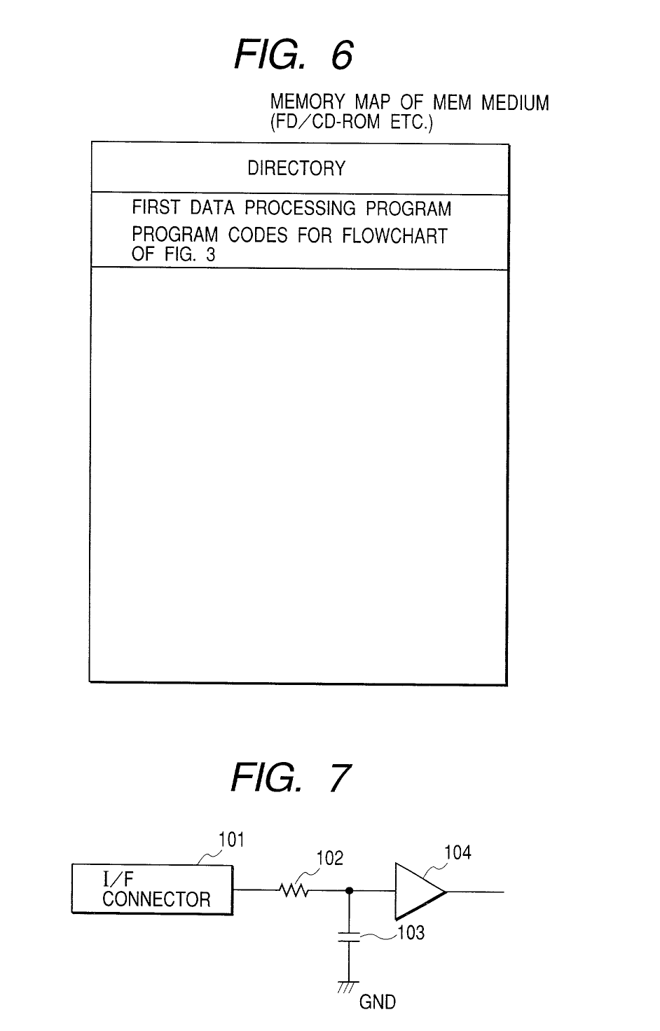

In the first embodiment, the apparatus can be also constructed in a manner such that the program for processing the data by the procedure shown in FIG. 3 is stored into a memory medium and a CPU on hardware (not shown) reads out the program and executes data processes in accordance with the read-out program. A construction of data processing programs which can be read out by the interface apparatus according to the invention will be described hereinbelow with reference to a memory map shown in FIG. 6.

FIG. 6 is a diagram for explaining the memory map in the memory medium for storing the various data processing programs which can be read out by the interface apparatus according to the invention.

Although not particularly shown, information for managing the programs which are stored into the memory medium, such as version information, names of persons who made the programs, and the like is also stored. There is also a case where information depending on an OS (operating system) or the like on the program reading side, such as icons for identifying and displaying the programs and the like is also stored.

Further, data depending on the various programs is also managed in directories. There is also a case where a program to install the various programs into a computer and, in the case where the program for installing them has been compressed, a program for decoding it, and the like are also stored.

The functions shown in FIG. 3 in the embodiment can be also executed by a host computer in accordance with a program which is installed from the outside. In such a case, the invention is also applied to a case where information including the programs is supplied to an output device from a memory medium such as CD-ROM, flash memory, FD, or the like or from an external memory medium through a network.

Naturally, the objects of the invention are also accomplished by a method whereby a memory medium in which program codes of software for realizing the functions of the embodiments mentioned above have been stored as mentioned above is supplied to a system or an apparatus and a computer (a CPU or an MPU) of the system or apparatus reads out the program codes stored in the memory medium and executes processes based on the read-out program codes.

In such a case, the program codes themselves read out from the memory medium realize the novel functions of the invention and the memory medium in which the program codes have been stored constructs the invention.

As a memory medium for supplying the program codes, for example, it is possible to use a floppy disk, a hard disk, an optical disk, a magnetooptic disk, a CD-ROM, a CD-R, a magnetic tape, a non-volatile memory card, an ROM, an EEPROM, or the like.

The invention incorporates not only a case where a computer executes the read-out program codes, so that the functions of the embodiments mentioned above are realized but also a case where an OS (operating system) or the like which is operating on the computer executes a part or all of actual processes on the basis of instructions of the program codes, and the functions of the embodiments mentioned above are realized by those processes.

Further, the invention also incorporates a case where the program codes read out from the memory medium are written into a memory equipped for a function expanding board inserted into a computer or a function expanding unit connected to a computer, thereafter, a CPU or the like equipped for the function expanding board or function expanding unit executes a part or all of actual processes on the basis of instructions of the program codes, and the functions of the embodiments mentioned above are realized by those processes.

As described above, according to the embodiments of the invention, in the interface apparatus which is arranged between an upper apparatus (host) and the information processing apparatus and executes transmission and reception of various information including image information, when the image information which is formed by the upper apparatus and transmitted by the specific procedure is received, whether the state where the continuous information has been transmitted during a predetermined period of time has been detected or not is discriminated. Whether the received data has been transmitted by the specific procedure or not is logically discriminated. If it is determined that the received data has been transmitted by the specific procedure, the received image information is fetched. Therefore, in the case where the data is transmitted and received between the upper apparatus and the information processing apparatus by various protocols or the case where the data is transmitted and received between the upper apparatus and the information processing apparatus in a state where a data transfer speed changes, there is an effect such that more complicated noise components can be removed as compared with that of the conventional noise filter using the passive elements.

What is claimed is:

1. An interface apparatus for inputting information from an external apparatus, comprising:
a first circuit for, when the inputted information is information which was changed within a predetermined time, invalidating said information; and
a second circuit for, when the inputted information is not matched with a protocol, skipping said information.

2. An apparatus according to claim 1, wherein said first circuit comprises:
a data change detector for outputting a reset in the case where there is a change in said inputted information;
a timer for outputting a trigger after the elapse of a predetermined time after said reset was inputted; and
a data latch for inputting said trigger and fetching the information.

3. An apparatus according to claim 1, wherein said external apparatus forms the information such that same information does not continue.

4. An apparatus according to claim 1, wherein the information which is inputted from said external apparatus is inputted to said first circuit and the information fetched by said first circuit is inputted to said second circuit.

5. A printer comprising:
a first circuit for, when inputted information is information which was changed within a predetermined time, invalidating said information;
a second circuit for, when said inputted information is not matched with a protocol, skipping said information; and
a printer engine for printing the information fetched by said first circuit, that is, the information which was determined by said second circuit that it is matched with the protocol.

6. An information processing method comprising:
a first step of, when information inputted from an external apparatus is information which was changed within a predetermined time, invalidating said information; and
a second step of, when the information validated in said first step is not matched with a protocol, skipping said information.

7. A method according to claim 6, wherein said first step comprises:
a data change detecting step of outputting a reset in the case where there is a change in said inputted information;
a step of outputting a trigger after the elapse of a predetermined time after said reset was inputted; and
a step of inputting said trigger and fetching the information.

8. A method according to claim 6, wherein said external apparatus forms the information such that same information does not continue.

9. A method according to claim 6, wherein said first step is executed by a glitch noise filter and said second step is executed by a logical filter.

10. A printing method comprising:
a first step of, when inputted information is information which was changed within a predetermined time, invalidating said information;
a second step of, when said inputted information is not matched with a protocol, skipping said information; and
a step of printing the information fetched by said first step, that is, the information which was determined by said second step that it is matched with the protocol.
